(19) United States
(12) Patent Application Publication
(10) Pub. No.: US 2002/0189886 A1
(43) Pub. Date: Dec. 19, 2002

(54) Drive system for a motor vehicle

(76) Inventor: Hans Dieter Zambelli, Henndorf a. Wallersee (AT)

Correspondence Address: Douglas B. Teaney, Law Offices of Dick and Harris, Suite 3800, 181 West Madison Street, Chicago, IL, 60602, US

(21) Appl. No.: 10/171,145

(22) Filed: Jun. 13, 2002

(30) Foreign Application Priority Data
Jun. 15, 2001 (DE) 10129989.3
Jul. 6, 2001 (DE) 10134789.8

(51) Int. Cl. B60K 17/00

(52) U.S. Cl. 180/307

(57) ABSTRACT

A drive system with an internal combustion engine; with a main hydraulic system, which has a pump device actuated by the internal combustion engine; and with an electronic control unit, which controls the speed of the internal combustion engine and the output of the pump device, is known. According to the invention, the main hydraulic system has a hydraulic load branch, which can be connected to the circuit by a control element, and the control element can be actuated by the electronic control unit as soon as the measured actual speed of the internal combustion engine exceeds a tolerance range of the nominal speed setting.

### BACKGROUND OF THE DISCLOSURE

1. Field of the Invention

The invention pertains to a drive system for a motor vehicle, especially for a tracklaying vehicle, with an internal combustion engine; with a main hydraulic system, which has a pump device actuated by the internal combustion engine; and with an electronic control unit, which controls the rpm's of the engine and the output of the pump device.

2. Background Art

A drive system for a tracklaying vehicle, which is intended for use on ski slopes, is generally known. A tracklaying vehicle of this type is driven by hydraulic motors, one for each side of the vehicle, each of which is fed by a pump device. The two pump devices are driven by an internal combustion engine in the form of a diesel engine, acting via a power divider. Depending the cubic displacement of the diesel engine, it may not be able to provide enough engine braking power when the tracklaying vehicle is traveling down a ski slope. To prevent the vehicle from accelerating when traveling downhill, the driver of the tracklaying vehicle must ease back on the gas pedal.

The task of the invention is to create a drive system of the general type indicated above which offers increased braking power.

### SUMMARY OF THE INVENTION

This task is accomplished in that the main hydraulic system has a hydraulic load branch, which can be connected to the circuit by a control element, and in that the control element can be actuated by the electronic control unit as soon as the measured actual speed of the internal combustion engine exceeds the tolerance range of a nominal speed setting. As a result of the solution according to the invention, the main hydraulic system is used as a hydraulic brake, as a result of which additional braking power is made available to the internal combustion engine. In the main hydraulic system, energy is consumed by the hydraulic load branch, which provides an additional engine braking effect. It is preferable for the hydraulic load branch to consist of a hydraulic circuit which has a return line for the hydraulic oil to a hydraulic oil tank and which can be actuated by the control element. The actual speed of the internal combustion engine is measured and compared with the nominal speed set by the gas pedal. The nominal speed which has been set has a tolerance range, within which the actual speed is allowed to remain without any electronic intervention. As soon as the actual speed leaves the tolerance range, however, that is, as soon as it exceeds the nominal speed setting, the control element for the hydraulic load branch is actuated, as a result of which the hydraulic brake is automatically connected to the main circuit. It is advantageous for the tolerance range to be about 300 rpm for the use of the drive system according to the invention in a tracklaying vehicle for ski slopes with a diesel engine with the limited cubic displacement appropriate for this application. Because the main hydraulic system is used to provide the additional braking power, there is no need for modifications to the internal combustion engine to achieve the same end. It is easy to provide an appropriate hydraulic load branch with an actuatable control element, and it is also advantageous that already existing main hydraulic systems can be retrofitted with it.

In an embodiment of the invention, the hydraulic load branch has a pressure-limiting element, the switching threshold of which is below the maximum working pressure of the main hydraulic system. This ensures that the pump device operates at maximum output, because it will attempt to reach the working pressure of the main hydraulic system. As a result, the desired braking power is achieved.

In a further embodiment of the invention, the hydraulic load branch is formed by an overload circuit in the main hydraulic system, and a control means of the overload circuit is designed to serve additionally as the control element for the hydraulic load branch. As a result, the overload circuit can perform a dual function, and there is therefore no need for a separate hydraulic load branch. Depending on the position of the control means, either the one or the other load function is active. In the case of the first load function, a secondary pressure safety limit is provided, where the working pressure of the main hydraulic system is not allowed to exceed a certain value. The second load function corresponds preferably to the above-described hydraulic load branch.

In a further embodiment of the invention, the control means of the overload circuit has a pressure-limiting valve, the switching threshold of which is above the maximum working pressure of the main hydraulic system. The switching threshold of the pressure-limiting valve can be adjusted by the electronic control unit between an upper switching threshold and a lower switching threshold for the hydraulic load branch. In the case of a drive system used in a tracklaying vehicle for ski slopes, the main hydraulic system is preferably operated with an oil volume of 120 liters and a maximum working pressure of 200 bars. The additional braking power is preferably achieved by a pressure safety limit of 170 bars with a value of approximately 35 kW. The secondary pressure safety limit is preferably set to a value of 230 bars.

### BRIEF DESCRIPTION OF THE DRAWINGS

Additional advantages and features of the invention can be derived from the claims and from the following description of preferred exemplary embodiments of the invention, which are illustrated in the drawings:

FIG. 1 shows a block circuit diagram of a main hydraulic system of one embodiment of a drive system according to the invention, and

FIG. 2 shows another block circuit diagram of an additional embodiment similar to that of FIG. 1.

### DETAILED DESCRIPTION OF THE DRAWINGS

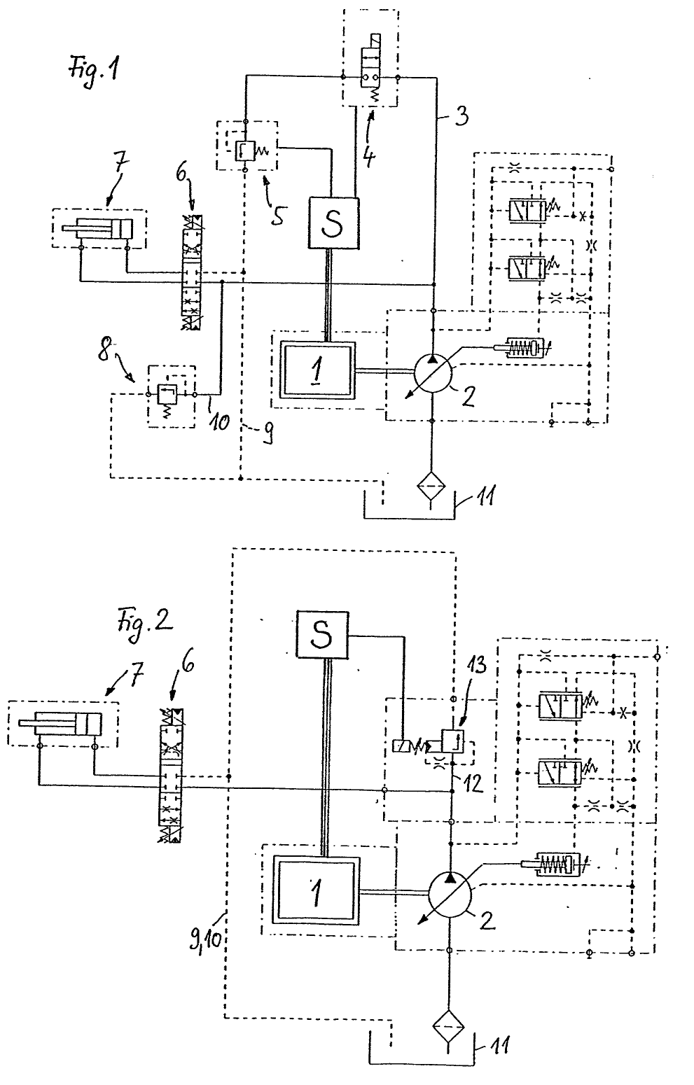

Both the drive system according to FIG. 1 and the drive system according to FIG. 2 are intended for use in the tracklaying vehicles used preferably on ski slopes. A tracklaying vehicle of this type has an internal combustion engine in the form of a diesel engine 1, which drives a pump device 2 for each side of the vehicle, that is, for each tracklaying mechanism. For this purpose, a power divider (not shown) is provided between the diesel engine 1 and the associated pump device 2. Each pump device 2 feeds one or more hydraulic motors, which are assigned to the drive wheels of the associated tracklaying mechanism. A drive system of this type is known in and of itself, so that there is no need to describe it in further detail here. In the case of the exemplary embodiments according to FIGS. 1 and 2, only a single pump device 2 is shown, which feeds one side of the vehicle. The pump device 2 is a part of the main hydraulic system, which, in addition to driving the associated tracklaying mechanism, also performs other work functions, especially in conjunction with various accessory devices attached to the front and rear of the vehicle. These, too, are known in and of themselves, so that there is no need to described them in detail here.

The electronic control unit S, which is suggested in FIGS. 1 and 2, is used to control the diesel engine 1 and the main hydraulic system. The electronic control unit S is connected to the gas pedal, which is operated by the driver of the tracklaying vehicle. The electronic control unit detects the position of the gas pedal and assigns to it a corresponding nominal speed for the diesel engine 1 from a characteristic diagram. The actual speed of the diesel engine is detected continuously.

When the vehicle is traveling along level ground, the position of the gas pedal and thus the desired nominal speed also correspond to the actual speed produced by the diesel engine. When the tracklaying vehicle travels downhill, the braking moment of the diesel engine must produce a braking power sufficient to work against the force of gravity acting on the vehicle and trying to draw the vehicle forward. If the diesel engine does not have enough cubic displacement to produce the required counter-moment, the speed of the diesel engine will increase, even though the position of the gas pedal has not changed. It would then be necessary for the driver to ease off on the gas pedal to reduce the rpm's of the engine.

So that increased braking power can be provided when traveling downhill even in the case of diesel engines or other types of internal combustion engines with insufficient cubic displacement, the main hydraulic system according to FIG. 1 is provided with an additional hydraulic load branch 3, 4, 5. This has a pressure-limiting valve 5 and a magnetic valve 4. Depending on its position, the magnetic valve 4 opens or closes a return line 9 leading to a tank 11 of the main hydraulic system. In the exemplary embodiment illustrated here, the pump device 2 is set to a maximum working pressure of 200 bars. The pressure-limiting valve offers a pressure safety limit at 170 bars. In addition, a secondary pressure limitation 8, which limits the pressure to 230 bars, is also provided in the form of an overload circuit. This, too, leads via a branch line 10 to the tank 11 when the valves are switched correctly. By way of example, an actuating element 6 of the main hydraulic system is shown in simplified form; this element represents the actuator for the working cylinder of a rake blade attached to the front end of the vehicle. In the case of the exemplary embodiment according to FIG. 1, the hydraulic load branch is provided as a separate circuit.

The control unit S monitors the results of the nominal/actual comparison of the speed of the diesel engine 1. As soon as the actual speed of the diesel engine 1 is more than 300 rpm's above the nominal speed value set by way of the gas pedal, which corresponds to the maximum tolerance range of the nominal speed, the hydraulic load branch is opened by appropriate actuation of the magnetic valve 4 and the pressure-limiting valve 5, as a result of which the diesel engine 1 is subjected to this additional load from the main hydraulic system. Because the pressure-limiting valve 6 limits the pressure to a value below the maximum working pressure, the pump device 2 operates at maximum output, because the control unit attempts to bring the pump device 2 to the set working pressure of 200 bars. Because the pressure is limited to 170 bars, an increased braking moment is obtained, which provides an additional braking power of about 35 kW. The secondary pressure limitation 8 in the present exemplary embodiment limits the pressure to 230 bars.

In FIG. 2, the overload circuit with a secondary pressure safety limit of 230 bars and the hydraulic load branch with a pressure limit of 170 bars are integrated into a common hydraulic circuit. For this purpose, a control element, which can be supplied with electric power and which is in the form of a two-stage pressure-limiting valve 13, is installed in a hydraulic line 12; the pressure-limiting valve is actuated by the control unit S. As long as the pressure-limiting valve 13 is not being supplied with current, it has a switching threshold of 230 bars, but when it is supplied with current, it has a switching threshold of 170 bars. On the basis of its monitoring of the actual speed of the diesel engine 1 and the comparison with the nominal speed set in each case by the gas pedal, the control unit S can, as needed, either keep the current to the pressure-limiting valve turned off or supply it with current. When, as previously described, the actual speed deviates from the nominal speed by more than 300 rpm, which, in the present exemplary embodiment, corresponds to the tolerance range of the nominal speed, the hydraulic load branch is connected to the circuit, as a result of which the corresponding amount of additional braking power is made available in the same way as in the exemplary embodiment described above.

1. A drive system for a motor vehicle, especially a tracklaying vehicle, with an internal combustion engine, a main hydraulic system having a pump device actuated by the internal combustion engine, and an electronic control unit which controls the speed of the internal combustion engine and the output of the pump device, comprising:
a hydraulic load branch associated with the main hydraulic system (3, 12), which can be connected to the circuit by means of a control element (4, 5; 13); and
wherein the control element (4, 5, 13) can be activated by the electronic control unit (S) as soon as the measured actual speed of the internal combustion engine (1) exceeds the tolerance range of a nominal speed setting.

2. The drive system of claim 1, wherein the hydraulic load branch has a pressure-limiting element (5, 13), the switching threshold of which is below the maximum working pressure of the main hydraulic system.

3. The drive system of claim 1, wherein the hydraulic load branch can be connected as a separate unit to the main hydraulic system.

4. The drive system of claim 1, wherein the hydraulic load branch is formed by an overload circuit present in the main hydraulic system, and wherein a control means (13) of the overload circuit is also designed to serve as the control element for the hydraulic load branch.

5. The drive system of claim 4, wherein the control means (13) of the overload circuit has a pressure-limiting valve, the switching threshold of which is above the maximum working pressure of the main hydraulic system, and wherein the switching threshold of the pressure-limiting valve (13) can be shifted by the electronic control unit (S) between an upper switching threshold and a lower switching threshold for the hydraulic load branch.
